(19) United States
(12) Patent Application Publication
(10) Pub. No.: US 2014/0144065 A1
(43) Pub. Date: May 29, 2014

(54) ADHESIVE-BASED PEST TRAP FOR USE WITH TOILETS

(71) Applicant: PATENTS INNOVATIONS, LLC, Venice, FL (US)

(72) Inventor: Aris MARDIROSSIAN, Potomac, MD (US)

(73) Assignee: PATENTS INNOVATIONS, LLC, Venice, FL (US)

(21) Appl. No.: 13/684,943

(22) Filed: Nov. 26, 2012

(51) Int. Cl. A01M 23/00

(52) U.S. Cl. CPC A01M 23/005
USPC 43/58

(57) ABSTRACT

Certain example embodiments of this invention relate to adhesive-based pest traps that can be used to trap pests (e.g., rodents such as rats or mice, cockroaches, spiders, snakes, etc.) trying to escape from a toilet or the like. For example, a trap may be disposed in, over, and/or around a toilet's bowl. The pest traps may be supported in the toilet's bowl by a plurality of arms and/or legs. An adhesive may be provided to one or more surfaces of the trap, e.g., so that pests traversing such surfaces are likely to become stuck thereon. In certain example embodiments, the adhesive may be baited to attract one or more particular types of pests. A poison also may be targeted to one or more of these particular types of pests in certain example embodiments.

### FIELD OF THE INVENTION

Certain example embodiments of this invention relate to pest traps. More particularly, certain example embodiments of this invention relate to adhesive-based pest traps that can be used to trap pests (e.g., rodents) trying to escape from a toilet or the like.

### BACKGROUND AND SUMMARY OF EXAMPLE EMBODIMENTS OF THE INVENTION

Unwanted pests like mice and rats can be a nuisance to landlords, tenants, and visitors alike. Indeed, the image of a rat climbing through a home's plumbing system and jumping out of a toilet is terrifying to some. The ability of rats to crawl through a piping system (e.g., connected to a public sewer system) and jump out of toilets, however, is not merely an “urban legend” or simply a “myth.” Rats are, in fact, quite agile and are good underwater swimmers. In fact, rats can quite easily crawl along a horizontal soil pipe from the sewer, swim through the water-filled piping inside the toilet, and emerge in the toilet bowl, particularly in first-floor and basement bathrooms.

Some may think that upper-floor bathrooms are safe from rats. For instance, some think that rats have a difficult time traversing a 5-6 foot vertical distance, particularly when the area has running water. However, in some cases, rats may enter a home or apartment, climb to that level, and then enter the piping. In other cases, a rat may climb the exterior of the building and enter into the piping through the roof or other area.

The ability of rats, rodents, and/or other pests to crawl through a building's piping and/or plumbing system is made easier when the water is turned off. For instance, rats may have an easier time entering into apartments and/or homes that have remained vacant for a time and where, for example, the water has been turned off.

There are some traps that may be used in toilet-related applications. Some current devices may be provided in the bent portion of the piping commonly referred to as the “trap,” which helps restrict the unwanted flow of sewer gasses and/or the like. However, such devices may be difficult to position, repair, and/or replace. Moreover, when they do capture a pest, they may unfortunately clog the pipes. The captured pest may die and begin the decomposition process, yielding a foul smell that even the “trap” sometimes cannot control.

Simply stated, there is a reason why the phrase “trying to build a better mousetrap” exists. Thus, it will be appreciated that there is a need for pest traps that can be disposed in or on a toilet, e.g., for capturing unwanted rodents and/or the like.

In certain example embodiments, a pest trap for a toilet is provided. A body portion has first and second surfaces opposite to one another. The body portion is shaped and contoured so that the first surface thereof is adapted to directly contact an inner surface of the toilet's bowl above a water line of the toilet. An adhesive material is provided to the body portion on the second surface thereof. A plurality of arms and/or legs extend from the body portion and are adapted to support the body portion in the bowl of the toilet.

In certain example embodiments, a pest trap for a toilet is provided. A body portion has first and second surfaces opposite to one another and separated by peripheral edge portions. The body portion is substantially planar and shaped and arranged so that the edge portions thereof are adapted to directly contact an inner surface of the toilet's bowl above a water line of the toilet around all or substantially all of a circumferential area of the toilet's bowl. An adhesive material is provided to the first and/or second surface(s) of the body portion. A plurality of arms and/or legs extend from the body portion and are adapted to support the body portion in the bowl of the toilet.

The features, aspects, advantages, and example embodiments described herein may be combined to realize yet further embodiments.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a top plan view of a toilet with a first adhesive-based pest trap in accordance with an example embodiment;

FIG. 2 is a cross-sectional view of the toilet and adhesive-based pest trap shown in FIG. 1;

FIG. 3 is a partial perspective view of the pest trap shown in FIG. 1;

FIG. 4 is a top plan view of a toilet with a second adhesive-based pest trap in accordance with an example embodiment;

FIG. 5 is a cross-sectional view of the toilet and adhesive-based pest trap shown in FIG. 4;

FIG. 6 is a partial perspective view of the pest trap shown in FIG. 4;

FIG. 7 is a top plan view of a toilet with a third adhesive-based pest trap in accordance with an example embodiment;

FIG. 8 is a cross-sectional view of the toilet and adhesive-based pest trap shown in FIG. 7;

FIG. 9 is a partial perspective view showing the top of the pest trap shown in FIG. 7;

FIG. 10 is a partial perspective view showing the bottom of the pest trap shown in FIG. 7;

FIG. 11 is a top plan view of a toilet with a fourth adhesive-based pest trap in accordance with an example embodiment;

FIG. 12 is a partial perspective view showing the top of the pest trap shown in FIG. 11; and

FIG. 13 is a partial perspective view showing the bottom of the pest trap shown in FIG. 11.

### DETAILED DESCRIPTION OF EXAMPLE EMBODIMENTS OF THE INVENTION

Certain example embodiments of this invention relate to adhesive-based pest traps that can be used to trap pests (e.g., rodents) trying to escape from a toilet or the like. For example, a trap may be disposed in, over, and/or around a toilet's bowl. An adhesive may be provided to one or more surfaces of the trap, e.g., so that pests traversing such surfaces are likely to become stuck thereon. In certain example embodiments, the adhesive may be baited to attract one or more particular types of pests such as, for example, rats, mice, cockroaches, spiders, snakes, and/or the like.

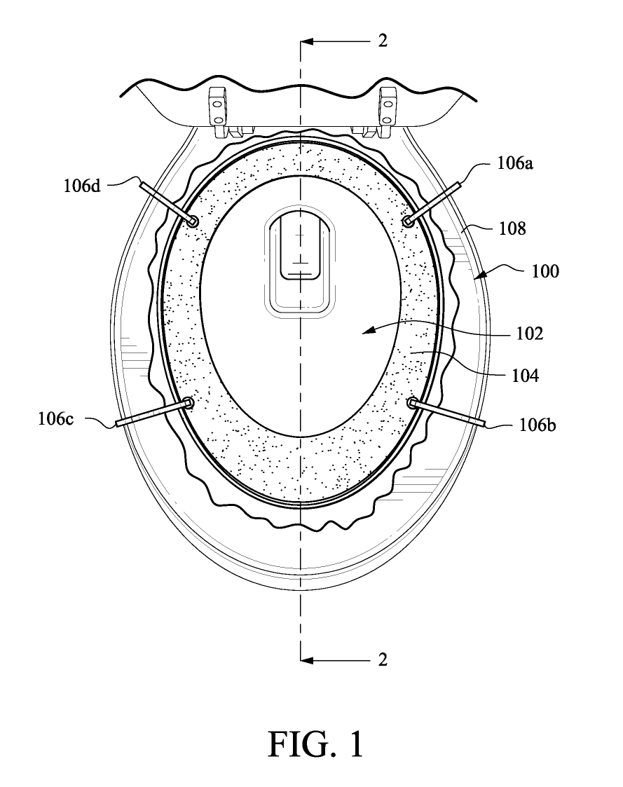

Referring now more particularly to the drawings in which like reference numerals indicate like parts throughout the several views, FIG. 1 is a top plan view of a toilet 100 with a first adhesive-based pest trap 104 in accordance with an example embodiment. As is conventional, the toilet 100 includes an inner bowl surface 102 and an outer rim 108. The pest trap 104 shown in FIG. 1 is sized and shaped so as to fit snugly to and extend around the circumference of the inner bowl surface 102. A plurality of arms 106a-106d are disposed around the pest trap 104 and essentially clip around the outer rim 108 so as to hold the pest trap 104 in place. Although four arms 106a-106d are shown in the FIG. 1 example embodiment, more or fewer arms may be used in different embodiments of this invention.

The pest trap 104 has an adhesive-coated surface that is opposite the side of the trap 104 that contacts the inner bowl 102. Any suitable adhesive material may be used in connection with the adhesive-coated surface of the pest trap 104. For instance, so-called “glue boards” have achieved some commercial acceptance. The adhesive material used in such glue boards may also be used in connection with certain example embodiments. In certain example embodiments, the adhesive material may be scented or otherwise provided with rat, rodent, and/or other pest bait so as to make the trap more enticing for the particular best. Bird seed, peanut butter, etc., are known rat baits. This may be advantageous to lure rats or other pests to the trap, regardless of whether they came through the plumbing or from somewhere else.

The adhesive material in addition, or in the alternative, may be provided with poison or the like, e.g., to kill one or more targeted pest(s). However, in certain example embodiments, the adhesive material may not be poisoned, e.g., to enable the pests to be caught and subsequently released in a potentially more humane way. In some cases, vegetable and/or other oils sometimes are sufficient for dissolving or at least weakening the adhesive material to a point where a pest can be freed.

A removable sheet or liner (not shown in FIG. 1) may be disposed over the adhesive material of the pest trap 104 in certain example embodiments, e.g., for packaging, shipment, and installation. When the pest trap 104 is put into position, the removable liner may be removed, exposing the adhesive. One or more tabs (also not shown in FIG. 1) may be provided for facilitating the removal of the liner. In certain example embodiments, the removable liner may be translucent, e.g., to help viewers know that it is still protecting the underlying adhesive and should be removed when the trap is ready for use.

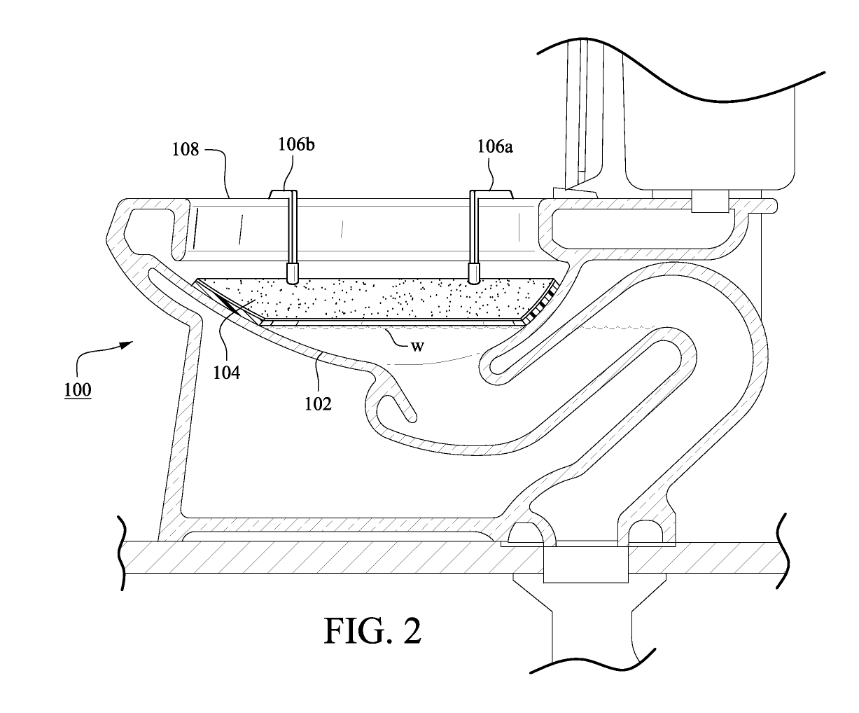

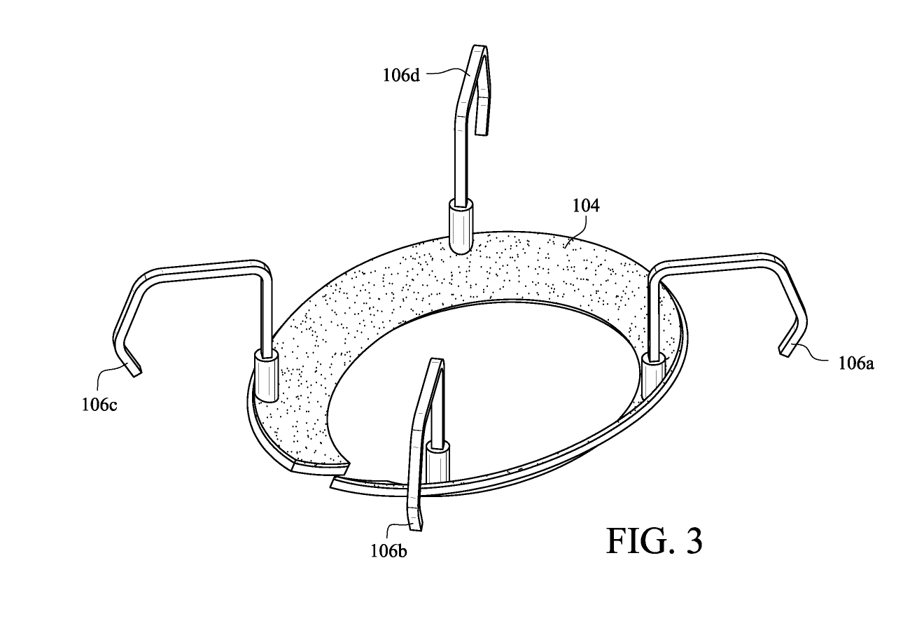

FIG. 2 is a cross-sectional view of the toilet and adhesive-based pest trap shown in FIG. 1, and FIG. 3 is a partial perspective view of the pest trap shown in FIG. 1. As shown perhaps best in FIG. 2, the pest trap 104 may be sized and shaped such that it can be placed just above the water line w of the toilet when the toilet is filled with water. It also may be sized and shaped so as to occupy a substantial portion of the inner bowl surface 102 above the waterline and under the upper rim 108. In certain example embodiments, one-third of this distance may be covered, whereas one-half to three-quarters or even more of this distance may be covered in other example embodiments. Covering a larger area may increase the likelihood of a pest being trapped, particularly if it attempts to jump out of the toilet bowl and/or climb out while still wet or damp. That is, the increased area may in some cases lead to increased distances along which the pest may travel and be exposed to, thereby potentially leading to an increased likelihood of capture. On the other hand, orienting the pest trap 104 above the water line w reduces the likelihood that the adhesive material will be worn down over time by accidental exposure to water or water seeping into and migrating up through the material.

As indicated above, the arms 106a-106d may be configured to clip around the rim 108 of the bowl. In certain example embodiments, the clips may be pre-sized and shaped, e.g., such that they allow the adhesive portion to extend to a suitable depth in the toilet 100 and/or so that they clip around the rim 108. In certain other example embodiments, the arms may include two portions such as, for example, a rigid first portion adjacent to the adhesive material and a deformable second portion. A person could use this latter arrangement to form custom-sized and/or shaped clips. In still other example embodiments, the clips may have a telescoping arrangement for similar purposes.

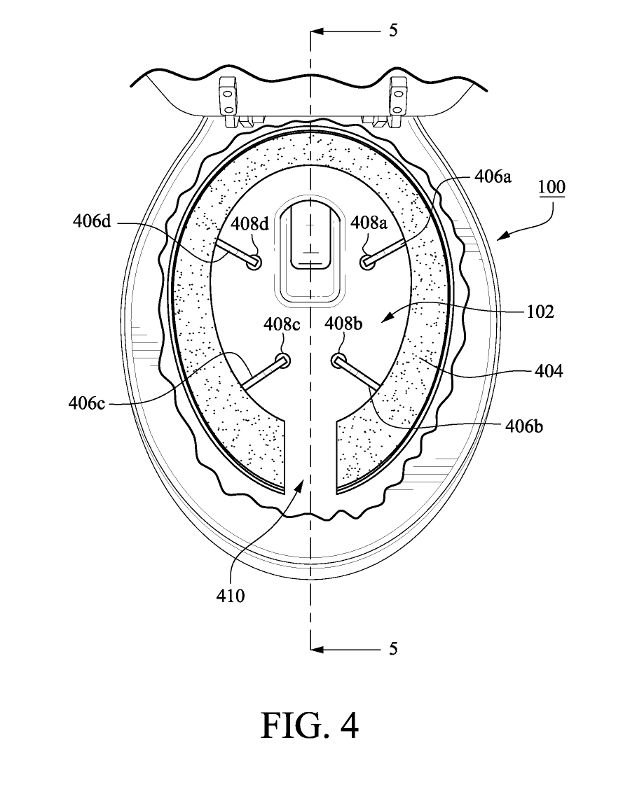

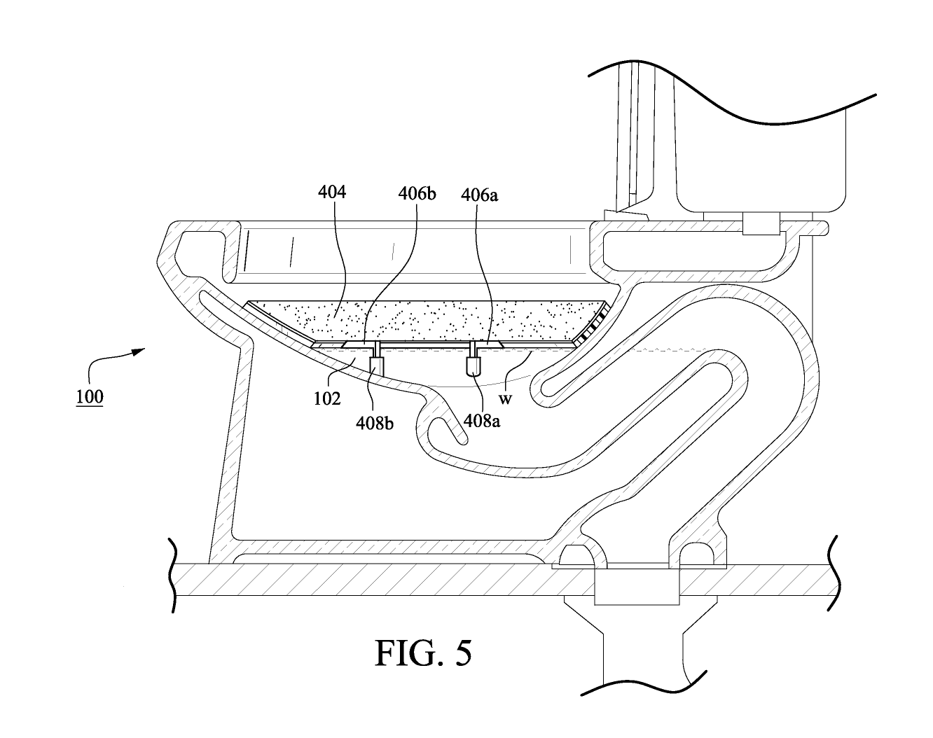

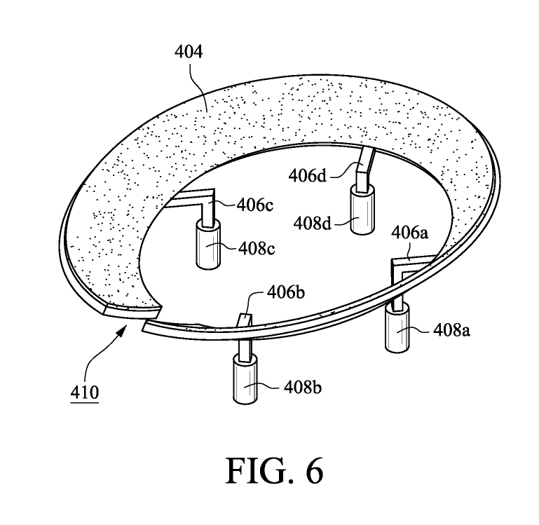

FIGS. 4-6 show another pest trap in accordance with certain example embodiments. More particularly, FIG. 4 is a top plan view of a toilet with a second adhesive-based pest trap in accordance with an example embodiment, FIG. 5 is a cross-sectional view of the toilet and adhesive-based pest trap shown in FIG. 4, and FIG. 6 is a partial perspective view of the pest trap shown in FIG. 4. The embodiment shown in FIGS. 4-6 is similar to the embodiment shown in and described in connection with FIGS. 1-3. However, as can be seen from FIGS. 4-6, the pest trap 404 includes a plurality of legs rather than a plurality of arms. Each of the legs in FIGS. 4-6 includes first and second portions 406 and 408. The first portions 406a-406d extend downwardly into the toilet 100, and the bases 408a-408b contact the inner bowl surface 102, supporting the pest trap 404 from the bottom (as opposed to clipping onto the rip 108 from the top as in the embodiment shown in and described in connection with FIGS. 1-3). In certain example embodiments, the base portions may be angled and/or otherwise structured so that they match a contour of the inner bowl surface 102. Although four legs are shown in FIGS. 4-6, more or fewer legs may be provided in different example embodiments. In certain example embodiments, the legs may have suction cups or the like disposed on ends thereof, e.g., to help hold the trap in place in the event that a larger and/or stronger pest comes in contact with the trap or portions thereof.

As shown perhaps best in FIG. 5, the pest trap 404 may be placed just about the water line w, e.g., as described above. Moreover, the legs' first portions 406a-406d may be deformable and/or telescoping, e.g., so as to enable one to adjust the height and/or placement of the pest trap 404 relative to the toilet 100.

FIGS. 4-6 also show an area 410 that is “removed” from the trap 404. In other words, the trap 404 may not be continuous and uninterrupted in certain example embodiments. This area 410 may be located proximate to an area where water would flow if the toilet were flushed or if water were to otherwise enter the bowl. This “missing area” may be advantageous because it may enable the trap to remain in place during normal operation of the toilet, and/or to reduce the likelihood of water coming into contact with the adhesive material and eroding it over time. It is noted that one or more “missing areas” 410 may be provided in different example embodiments, and that similar missing areas may be incorporated into the other designs disclosed herein.

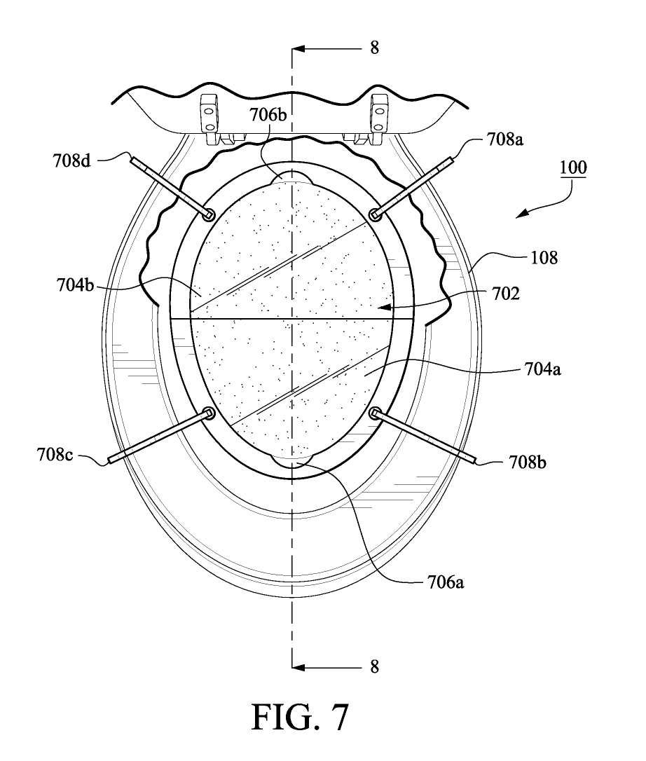

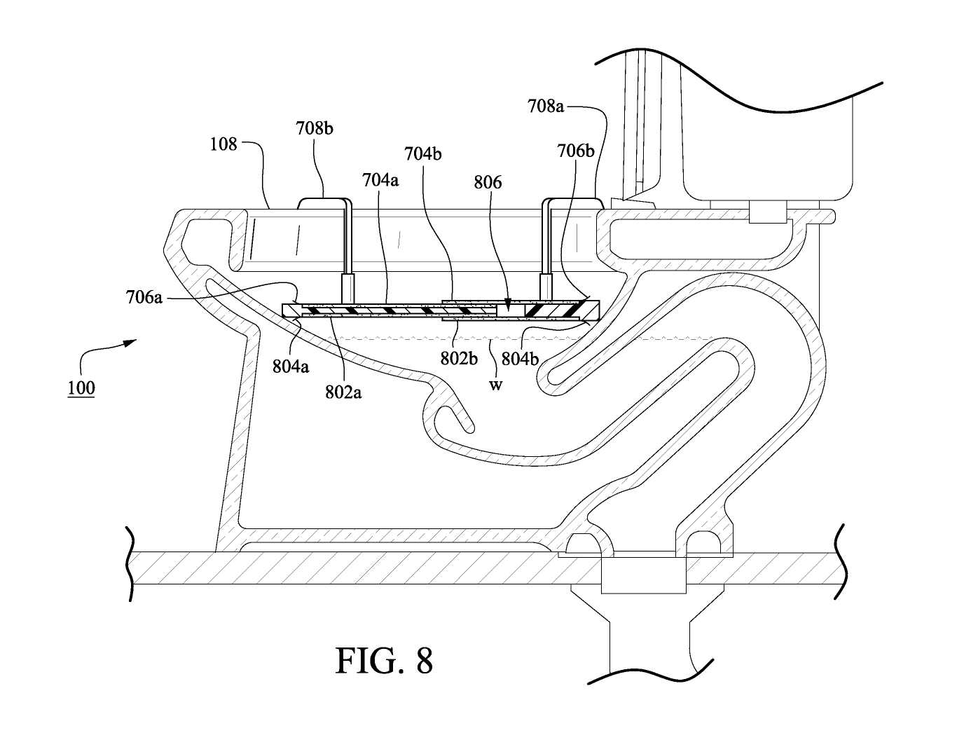

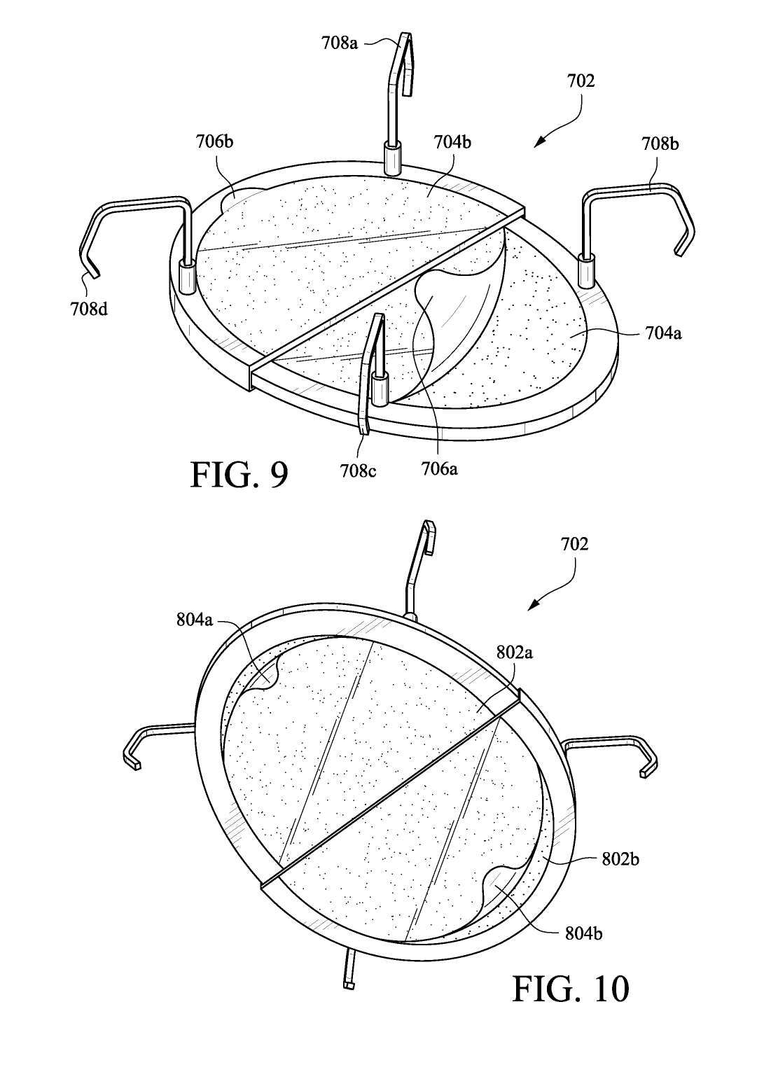

FIGS. 7-10 show another pest trap 702 in accordance with certain example embodiments. More particularly, FIG. 7 is a top plan view of a toilet with a third adhesive-based pest trap in accordance with an example embodiment, FIG. 8 is a cross-sectional view of the toilet and adhesive-based pest trap shown in FIG. 7, FIG. 9 is a partial perspective view showing the top of the pest trap shown in FIG. 7, and FIG. 10 is a partial perspective view showing the bottom of the pest trap shown in FIG. 7. Unlike the traps shown in FIGS. 1-6 and discussed above, the trap 702 shown in FIGS. 7-10 and described below is substantially planar and/or disc-shaped, and fits across the bowl.

The trap 702 includes upper front and rear portions 704a and 704b, respectively. These portions 704a and 704b may have an adhesive material disposed thereon. Upper front and rear upper pull tabs 706a and 706b may be used to remove sheets that protect the adhesive material prior to use. A plurality of arms 708a-708d may be provided, e.g., to engage with the rim 108 of the toilet bowl as described above in connection with FIG. 1.

The trap 702 also may include lower front and rear portions 802a and 802b, respectively. These portions also may have an adhesive material disposed thereon, and lower pull tabs 804a and 804b may be used to remove sheets that protect the adhesive material prior to use.

Because the trap 702 fits across the bowl, rats may be trapped as they try to jump out and become stuck to the lower front and/or rear portions 802a, 802b. Alternatively, if rats do manage to escape, or try to enter into the bowl, they may become stuck to the upper front and rear portions 704a and 704b.

As shown in FIG. 8, the substantially planar trap 702 may be disposed just above the water line w in certain example embodiments. In other example embodiments, the trap 702 may be provide so as to cover more or less of the volume.

In fact, in certain example embodiments, the trap may sit across the top of the toilet rim. In such cases, the trap may rest on the rim of the toilet and clip to the sides via arms and/or clip to an area under the rim for stability. Legs additionally or alternatively may be provided.

In certain example embodiments, the size and/or shape of the trap 702 may be adjustable. For example, as shown perhaps best in FIG. 8, a channel 806 may be provided. The channel 806 may enable the front and back portions of the trap 702 to expand or contract in the major and/or minor distance direction(s). As a result, the trap 702 may be used in connection with a potentially broader number of toilets of different configurations. Of course, certain example embodiments need not include such features and, instead, certain example embodiments may be provided with “fixed” sizes that are suitable for use with standard toilets.

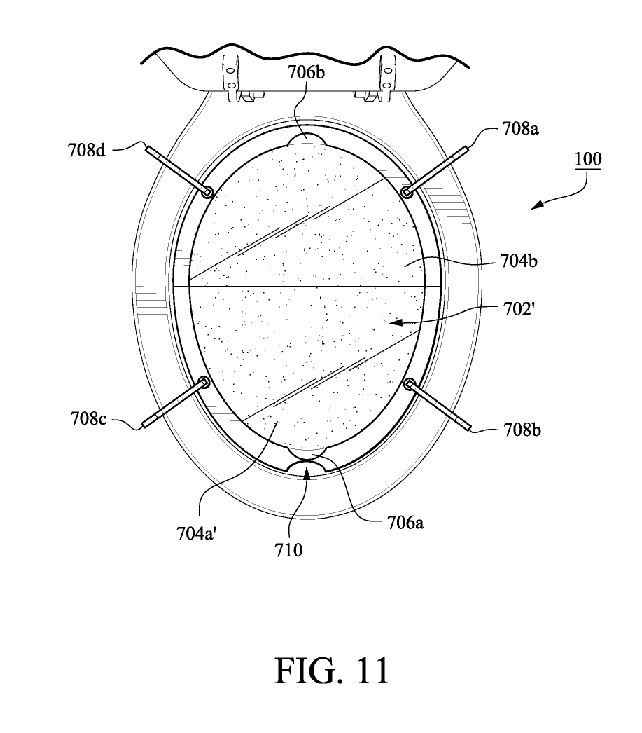

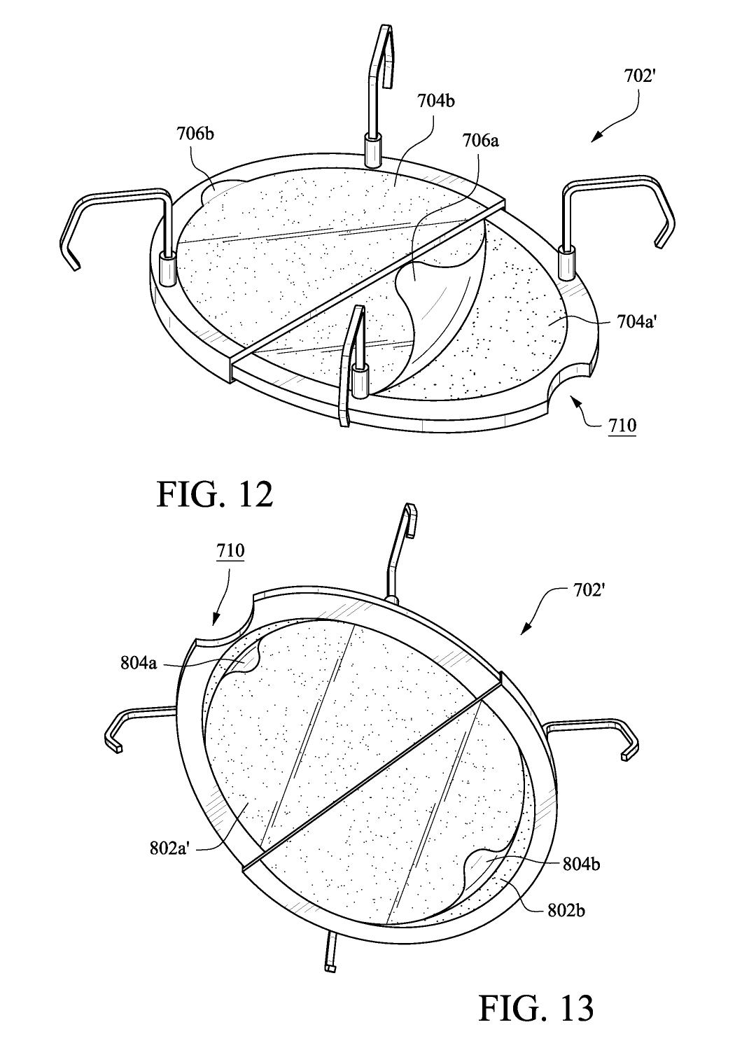

FIGS. 11-13 show another pest trap 702′ in accordance with certain example embodiments. In that regard, FIG. 11 is a top plan view of a toilet with a fourth adhesive-based pest trap in accordance with an example embodiment, FIG. 12 is a partial perspective view showing the top of the pest trap shown in FIG. 11, and FIG. 13 is a partial perspective view showing the bottom of the pest trap shown in FIG. 11. The pest trap 702′ shown in FIGS. 11-13 is similar to that shown in FIGS. 7-10. However, the front portion 702a′ of pest trap 702′ includes an area 710 that is “removed” from the trap 702′. This area 710 may be similar to the area 410 discussed above in connection with the trap 404, in that it may be located proximate to an area where water would flow if the toilet were flushed or if water were to otherwise enter the bowl. This “missing area” may be advantageous because it may reduce the likelihood of water coming into contact with the adhesive material and eroding it over time. It is noted that one or more “missing areas” 710 may be provided in different example embodiments.

It will be appreciated that the embodiments shown in and described in connection with FIGS. 7-13 may include “legs” similar to those described in connection with FIGS. 4-6 rather than the “arms” 708a-708d.

It also will be appreciated that the various embodiments may be combined in various combinations and sub-combinations to yield yet further embodiments. For example, the embodiments shown in and described in connection with FIGS. 1-6 may be combined with FIGS. 1-7, e.g., to provide what in some ways might seem like a more comprehensive trap. That is, in certain example embodiments, a trap may be provided that includes a disc-like substantially planar portion similar to that shown in FIG. 7, as well as a portion that extends around the inner surface of the bowl. These portions may be integrally formed in certain example embodiments. In certain example embodiments, the various adhesive-coated surfaces may be protected separately.

In view of the foregoing, it will be appreciated that certain example embodiments provide an easy to install trap for ensnaring pests. Such traps may be easy to position and may be disposable, e.g., after they have been checked, are no longer needed, have served their purposes (by, for example, capturing pests while a person is not occupying a particular place), etc. Such traps may be provided to toilets that are not often used; in houses, apartments, stores, and/or other facilities that are expected to remain vacant such as, for example, rental properties, weekend or summer/winter homes, etc.; and/or in other locations and/or situations.

Because the adhesive materials may be protected by a temporary sheet that is removable (e.g., by peeling), the traps may be stored and used when and as desired. The further provision of potentially adjustable arms and/or legs may enable a user to simply “drop” a trap according to certain example embodiments into place, and remove it easily when done. And if the traps will be checked with sufficient frequency, they may in some instances provide for a potentially more humane treatment of captured pests as compared to conventional traps that simply trap and kill such pests.

The body and/or other portion(s) may be formed from any suitable material. For instance, in certain example embodiments, the body and/or other portion(s) may be formed from plastaic, metal, cardboard, and/or the like. A resilient plastic or other body portion may support a separate adhesive layer thereon in certain example embodiments.

Although certain example embodiments have been described in connection with rats, it will be appreciated that the techniques disclosed herein may be used in connection with almost any kind of pest. For instance, the example traps disclosed herein may be used to trap all kinds of rodents (including rats and mice), cockroaches, spiders, snakes, and/or the like. In some cases, a common bait may be used to lure one or more different types of pests. In other cases, no bait need be provided to the trap.

Different embodiments may include different strength adhesives to help facilitating the capture of different types of pests. Furthermore, in certain example embodiments, the adhesive material(s) may be water insoluble, and/or may be resistant to water exposure and/or encroachment such that the adhesive strength does not degrade after exposure to water (e.g., from the toilet's bowl, a leaky valve, a wet pest, and/or the like).

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A pest trap for a toilet, comprising:
a body portion having first and second surfaces opposite to one another, the body portion being shaped and contoured so that the first surface thereof is adapted to directly contact an inner surface of the toilet's bowl above a water line of the toilet;
an adhesive material provided to the body portion on the second surface thereof; and
a plurality of arms and/or legs extending from the body portion and adapted to support the body portion in the bowl of the toilet.

2. The pest trap of claim 1, further comprising a removable protective sheet disposed over the adhesive material.

3. The pest trap of claim 2, further comprising a pull tab connected to the removable protective sheet, the pull tab facilitating removal of the protective sheet once the trap has been put into place.

4. The pest trap of claim 1, wherein a plurality of arms are provided, each said arm extending generally upwardly from the body portion and having a clip on an end thereof for engaging with a rim of the toilet to hold the trap in place relative to the bowl.

5. The pest trap of claim 4, wherein at least a portion of each said arm is deformable.

6. The pest trap of claim 1, wherein a plurality of legs are provided, each said leg extending generally downwardly from the body portion and having an end for contacting parts of the toilet to hold the trap in place relative to the bowl.

7. The pest trap of claim 6, wherein the ends of the legs are angled and/or contoured so as to match a corresponding angle and/or contour of the bowl.

8. The pest trap of claim 6, wherein the ends of the legs include suction cups.

9. The pest trap of claim 1, wherein the arms and/or legs are disposed around the body portion at regular intervals.

10. The pest trap of claim 1, wherein the body portion is substantially U-shaped when viewed from a top plan perspective, a gap between adjacent ends of the U-shaped body portion being provided at an area corresponding to where water would flow into the toilet.

11. The pest trap of claim 1, wherein the body portion is sized so that a distance between upper and lower edges thereof occupies at least 50% of a distance between the water line and a rim of the toilet.

12. A pest trap for a toilet, comprising:
a body portion having first and second surfaces opposite to one another and separated by peripheral edge portions, the body portion being substantially planar and shaped and arranged so that the edge portions are adapted to directly contact an inner surface of the toilet's bowl above a water line of the toilet around all or substantially all of a circumferential area of the toilet's bowl;
an adhesive material provided to the first and/or second surface(s) of the body portion; and
a plurality of arms and/or legs extending from the body portion and adapted to support the body portion in the bowl of the toilet.

13. The pest trap of claim 12, wherein the edge portions are angled and/or contoured to match a corresponding angle and/or contour of the bowl.

14. The pest trap of claim 12, further comprising at least one removable protective sheet disposed over the adhesive material.

15. The pest trap of claim 12, further comprising a pull tab connected to each said removable protective sheet.

16. The pest trap of claim 12, wherein a plurality of arms are provided, each said arm extending generally upwardly from the body portion and having a clip on an end thereof for engaging with a rim of the toilet to hold the trap in place relative to the bowl.

17. The pest trap of claim 12, wherein a plurality of legs are provided, each said leg extending generally downwardly from the body portion and having an end for contacting parts of the toilet to hold the trap in place relative to the bowl.

18. The pest trap of claim 17, wherein the ends of the legs are angled and/or contoured so as to match a corresponding angle and/or contour of the bowl.

19. The pest trap of claim 12, wherein the adhesive material is provided to both the first and second surfaces.

20. The pest trap of claim 12, wherein the body portion comprises first and second portions, the second portion including a channel into and from which the first portion is slidable.
